(19) United States
(12) Patent Application Publication
(10) Pub. No.: US 2021/0264468 A1
(43) Pub. Date: Aug. 26, 2021

(54) SYSTEM AND METHOD FOR PROMOTING ENGAGEMENT AND ACTIVISM IN A SOCIAL, POLITICAL OR ENVIRONMENTAL CAUSE

(71) Applicant: Arizae LLC, San Rafael, CA (US)

(72) Inventors: Ken Kurtzig, San Rafael, CA (US); Jarrod Russell, Mill Valley, CA (US)

(21) Appl. No.: 17/182,134

(22) Filed: Feb. 22, 2021

Related U.S. Application Data
(60) Provisional application No. 62/979,368, filed on Feb. 20, 2020.

(51) Int. Cl. G06Q 30/02

(52) U.S. Cl. CPC G06Q 30/0256; G06Q 30/0242; G06Q 30/0276

(57) ABSTRACT

A system and method for promoting engagement and activism in a cause are disclosed. The system and method include presenting a website that is servable to one or more client computers by a server computer, the website being configured to display one or more webpages that are generated by the server computer. The system and method include at least one webpage associated with the website and comprising a window displaying a call to action that is based on data relating to an activity to be accomplished by one or more users of the one or more client computers, each user being associated with a group, the call to action being defined as a window of the web page and having one or more user-selectable buttons related to accomplishment of the activity by a user of the one or more users.

### CROSS-REFERENCE TO RELATED APPLICATIONS

The current application claims priority under 35 U.S.C. § 119(e) to provisional application Ser. No. 62/979,368 filed Feb. 20, 2020. The disclosure of each application cited in this paragraph is incorporated herein by reference in its entirety.

### TECHNICAL FIELD

The subject matter described herein relates to promoting engagement by users in causes, and more particularly to a system and method, implemented as an on-line platform, for promoting engagement and action in a social, political, or business cause.

### BACKGROUND

Participation in activism, advocacy, and the greater civic sphere is a disparate and often confusing process for most people and organizations, making it difficult to not only find the right tools, actions, and next steps to advance a given cause that they care about, but also to have a sense of individual progress, personalized journeys, and a sense of community-driven collective impact over time.

To put it simply, doing good in the world—across issues, organizations, and over time—has been characterized by bad online user experiences, making doing good less accessible, less measurable, more isolated, under incentivized, and, frankly, less fun for a large portion of humanity—how could people more easily make an impact on the issues they care about, and build social capital online along the way; and what is the role of organizations and gamification in inspiring behaviours that motivate impactful, measurable actions?

### SUMMARY

This document presents a purpose-driven engagement platform that empowers organizations and groups, such as brands, nonprofits, and political organizations, to build and measure meaningful impact. The platform, and methods executed thereon, enables organizations and groups to engage their customers, members and employees through collective action on all the causes that matter most to them. The platform unlocks the power of purpose in one simple hub so that users can discover, share, and measure actions that drive positive change in their causes and in the world, engaging their personal networks and building their own sense of community impact along the way too.

In some aspects, a method and computer program product providing instructions for executing the method include receiving, from one or more client computers over a network, data relating to an activity to be accomplished by one or more users associated with a group, each of the one or more users further being associated with at least one of the one or more client computers, the activity. The method further includes generating a call to action based on the data related to the activity, the call to action being defined as a window of a web page and having one or more user-selectable buttons related to accomplishment of the activity by a user of the one or more users. The method further includes storing the call to action in a database, the storing including indexing the call to action to one or more search terms of a search request that is received by the server computer from at least one client computer via a search engine service. The method further includes accessing the call to action from the database upon receipt of the search request from the at least one client computer via the search engine service, the search request including at least one of the one or more search terms indexed to the call to action in the database. The method further includes serving the call to action to the at least one client computer as the window in the web page.

In other aspects, a system and method for promoting engagement and activism in a cause are disclosed. The system and method include presenting a website that is servable to one or more client computers by a server computer, the website being configured to display one or more webpages that are generated by the server computer. The system and method include at least one webpage associated with the website and comprising a window displaying a call to action that is based on data relating to an activity to be accomplished by one or more users of the one or more client computers, each user being associated with a group, the call to action being defined as a window of the web page and having one or more user-selectable buttons related to accomplishment of the activity by a user of the one or more users. The call to action is accessible from the web site by the one or more client computers via a search engine service that receives one or more search terms that are indexed to the call of action in a database associated with the server computer.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an experience using desktop functionality on a web browser, it should be readily understood that such features are not intended to be limiting and that these features could also occur in other contexts such as a mobile app or a widget for a web browser. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A-1E show various user interfaces (UIs) and window generated by the platform;

FIG. 2 shows an account setup screen;

FIG. 3 shows example informational CTA surveys;

FIG. 4 illustrates a levels and tile UI based on CTA creation;

FIGS. 5A-5C illustrate CTA creation, particularly for admin/settings, etc.;

FIGS. 6A-6C illustrate button/modal creation;

FIGS. 7A-7C illustrate a CTA completion;

FIG. 8A depicts an exemplary modal from a user view;

FIG. 9 shows a user table generated by the platform for users to push or send relevant, timely CTAs to other users;

FIG. 10 shows a sub-group leaderboard;

FIGS. 11A and 11B illustrate sub-group action sharing; and

FIG. 12 illustrates a table for representing groups or group owners.

FIG. 13 is a block diagram of a system and platform for promoting engagement and activism in a social, political or environmental cause.

When practical, similar reference numbers denote similar structures, features, or elements.

### DETAILED DESCRIPTION

This document presents a method, and a system for executing the method, for generating and providing actions for a user that can be tracked and measured using a computing device, in order to maximize social, political and environmental impact. The system and its computing processes provide a centralized platform to use gamification as well as action tracking and measurement to allow users to participate in impact-making endeavors, such as political campaigns, voter participation and canvassing, employee engagement, customer engagement, community engagement, cause-driven organizations, cause-marketing, fundraising, community challenges, events, conferences, etc.

In preferred implementations of the current subject matter, the system implements what is known as a simple “action journey” for each of its users, where each user can set up, view and act on those actions that the user cares about. The action journey is defined by one or more “Calls to Action” (CTAs), which can be created by each individual user, and/or a group or organization to which the user is affiliated. Users can follow or join groups or organizations to monitor CTAs, either their own or others in the group or organization, and which can build networks and crowdsourced actions via user-base voting and point accumulation via the gamification features of the system, as is described in more detail below.

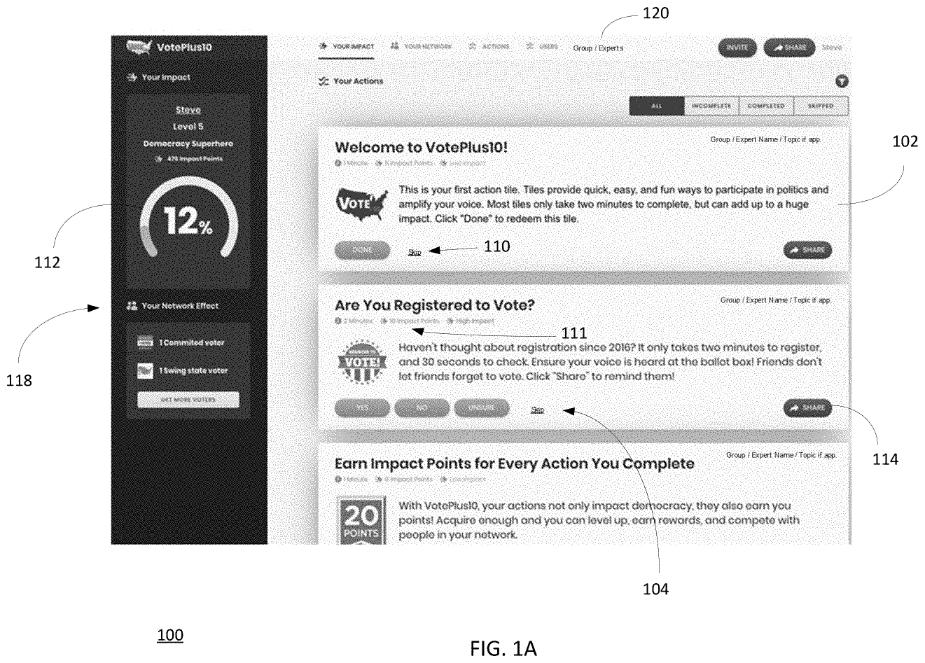

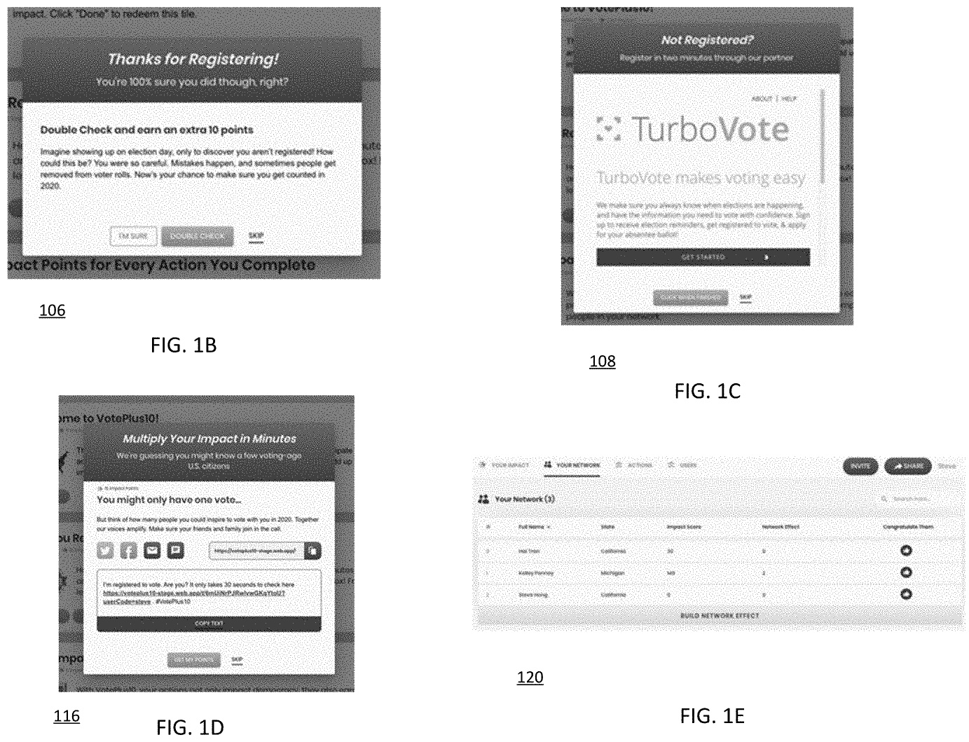

FIG. 1A shows a user interface (UI) 100 generated by the platform. The platform generates a number of key components for display in the UI 100, which can be tailored for and distributed to any number of users that are part of an organization or group, for enabling the organization or group to engage their customers, members and employees (herein referred to as “users”) through collective action on the causes that are defined and to which metrics and performance scores are applied.

As shown in FIG. 1A, the platform presents one or more Calls to Action (individually, “CTA 102”). Each CTA 102 can be presented as a window or tile in the UI 100, and provide suggested actions for each user. In some implementations, they are measured in minutes, and by impact and a point value. The point value is accumulated by a user accomplishing real-life actions proscribed by the CTA 102. Users can scroll through all CTAs 102 associated with their level and any groups/experts they follow. They can sort on various parameters as well. Each CTA 102 is associated with a point value, at least a portion of which can be accumulated by each user for incremental accomplishment of the actions proscribed by the CTA 102.

The CTA 102 can include one or more action buttons 104. Action buttons such as responses like “yes,” “no,” “unsure,” and/or “skip,” for example, can be provided in direct response to the content in each CTA 102. For instance, a CTA 102 may seek an action response such as “yes,” “no,” “unsure,” and/or “skip,” which each can be rendered as user-selectable buttons within the window or tile of the CTA 102, but other action responses can be solicited and rendered, such as a sliding numerical or qualitative scale, or other representations of responses to called-upon actions. The action buttons 104 allow users to input information as to their completion of an associated CTA 102.

There are general CTAs 102 for every user, and there are CTAs 102 that are generated by user characteristics (e.g. state, age, gender, interest, etc.) to create a unique user journey, such as, without limitation, individual characteristics of users or the group, the groups/experts they follow, the issues they care about, etc.

In implementations where control buttons 104 depict the inputs of “yes,” “no,” “unsure,” and/or “skip,” FIG. 1B illustrates a pop-up window that is generated upon the user selecting the “yes” button, and FIG. 1C illustrates a pop-up window that is generated upon the user selecting the “no” button. These illustrations are examples of the different information a user can see, within pop-up windows or separate UI screens or otherwise, by their selection of the different action buttons 104 within each CTA 102.

CTAs 102 are in turn defined by a modal, i.e. as represented by the content and/or context of the CTA 102, and can be populated with internally-sourced content (e.g. yes), or iFrame/API connections to integrated solutions (e.g. “no” button links to an external site such as TurboVote™ for example). In some implementations, a user can have the ability to skip individual CTAs 102 by a user graphically accessing a “skip” button 110, according to which the user input designates the associated CTA to a skipped section. Alternatively, the platform can allow a user to decline a CTA, which also functions as a skip.

If user skips a CTA 102, they do not get penalized, however, they are taking the CTA out of an “incomplete” field, which is essentially their to-do list for CTAs 102, which have been provided to them either by user selection or by an external source, such as a group to which they belong, or another group that designates the CTA as a challenge. They can return to Skipped and complete CTAs later to receive points if they would like. When the actions proscribed by a CTA 102 are completed, via direct actions in the CTA 102 window via action buttons 104, by the user and/or affirmative buttons, the user will be designated to receive associated points, and the completed CTA will be allocated to a “completed” section of the UI 100 on the platform.

As shown in FIG. 1A, a number of impact points 111 can be earned through direct actions prompted within the system associated with control buttons 104 on the CTAs 102, or through actions taken with any number of integrated solutions (either direct or latent via data sharing to corroborate actions in other systems, for example). Users can also earn a percentage, i.e. 1/10, of points for all actions from users they have invited to the platform and/or to any specific CTA 102.

The impact points 111 can be tracked, measured, and/or calculated by the platform, and displayed graphically in an impact window 112. The impact window 112 can graphically show a progress, i.e. by percentage, of a user's progress toward a goal, such as a goal number of cumulative impact points 111. The impact window 112, as a separate window or tile in the UI 100, can also display user information, status, or other information related to that user's progress within the platform. The platform allows users to accumulate and use impact points 111 for a number of reasons, including, but not limited, to: measure impact in society and feel a sense of progress; win competitions and prizes, within groups and across the platform; encourage and/or compete with friends using leaderboards; advance to new levels to unlock new status and CTAs 102, and other reasons.

Each CTA 102 in the UI 100 can include a “share” button 114, that, when selected by a user, generates a modal within the application of the platform. The share button 114 is a link that executes a referral function, i.e. implements electronic distribution of the CTA content to other users, to allow a user to grow their personal network. If user clicks the share button 114 on a CTA 102, some or all of the content and/or context of the CTA 102 is shared with one or more new or other users for them to complete without having to log in to the platform. If the CTA 102 is from a group (i.e. not general) and the user follows the group, network growth occurs for both the user and the network if new users join platform due to user's unique link.

A user's and/or group's unique links from any tile in the UI 100 share buttons, with which to “inbound” new users directly to a public modal that new users can view outside of the application, with related CTA content and action button 104. After new users accept or decline the action, they are sent to a join form with referral tracking for the referring user and/or group. Tracking is automated on backend based on tile type and administrator symbol triggers (e.g. {{user_x}}). Users can get points for sharing CTA content.

Users and groups can build their network with unique links via share buttons 114 and/or via their account details, to generate a network effect window 118, which can display results of a user's efforts. Users can also be discoverable if they choose to make their profiles public. There is also the possibility for communication within and across these networks. Users/groups also get a percentage of the impact points earned by those they recruit into the system and those that follow them, as well as additional points for certain strategic attributes of their network for a given issue or cause. In one example, in a case for voter turnout, committed voters and swing state voters recruited can be allocated 3 points each. The desired outcomes can be adjusted.

Leaderboards 120, accessed in UI 100 and shown in FIG. 1E as a pop-up window, based on impact points can be used within/across groups, the platform, and for competitions and prizes. Some can be all-time, others can be time-bound, creating urgency for certain actions, issues, and causes. Groups and experts can have the ability to secure reward/prize sponsors via the platform for competitions within their respective networks.

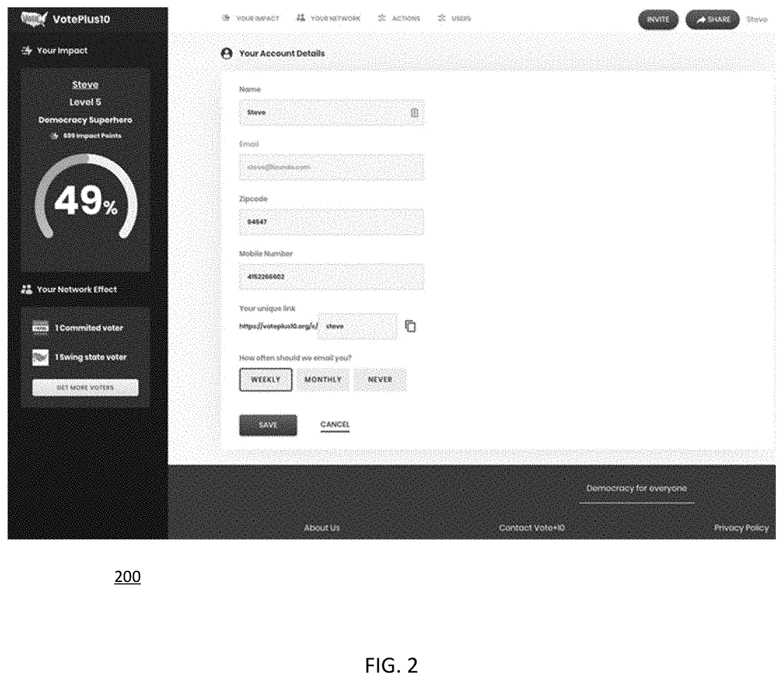

FIG. 2 shows an account setup screen 200, for allowing users to input account details/privacy settings and other user information. Each user can have the ability to update various information, including, but not limited to: name; zip code; mobile phone number; how often they can be contacted; how or by what means they can be contacted; privacy level/user visibility (i.e. public, partial, private). In terms of privacy level, the following levels can be applied: public—where their full name would show up on leaderboards and other discoverable forums within the application; partial—where the user could create a unique abbreviation or alias of their choosing for said forums; and private—where a system generated anonymous identifier can be generated anywhere the user appears in forums, or they can opt out entirely. Users can adjust visibility across groups, competitions, issues, leaderboards on a case by case basis, including at the user-to-user level.

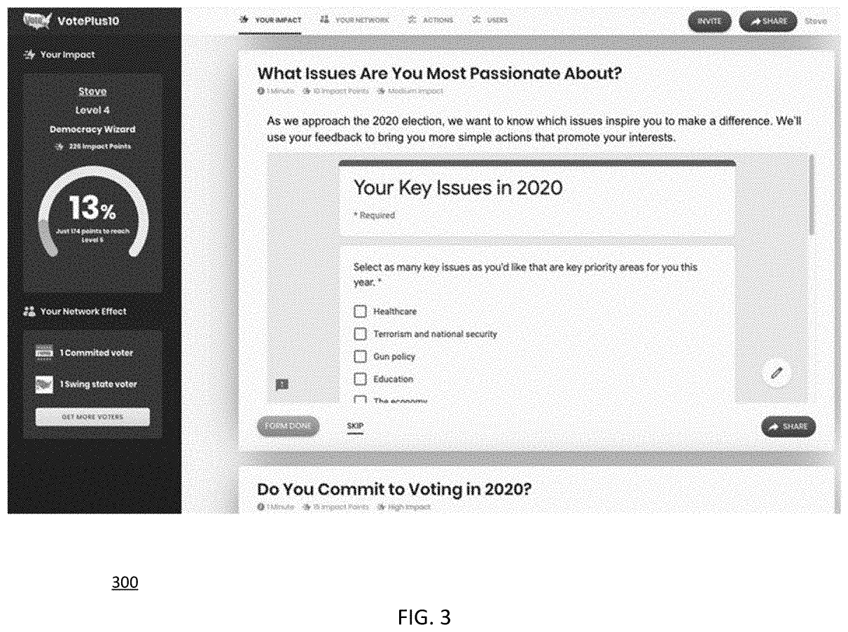

Via the platform, users can submit various unique informational CTA surveys 300 that help determine upcoming CTA composition, as shown in FIG. 3. If a user selects healthcare as a key issue, for example, then subsequent CTAs on the platform backend related to healthcare will be automatically prioritized for that user. Users can also complete surveys where they prioritize new functionality or features that the application development team is considering, as well as add new ideas. User feedback then determines the engineering team's rollout of new features. Similarly to new application features, users can propose new CTAs at any level (system, group, issue, competition, etc.)

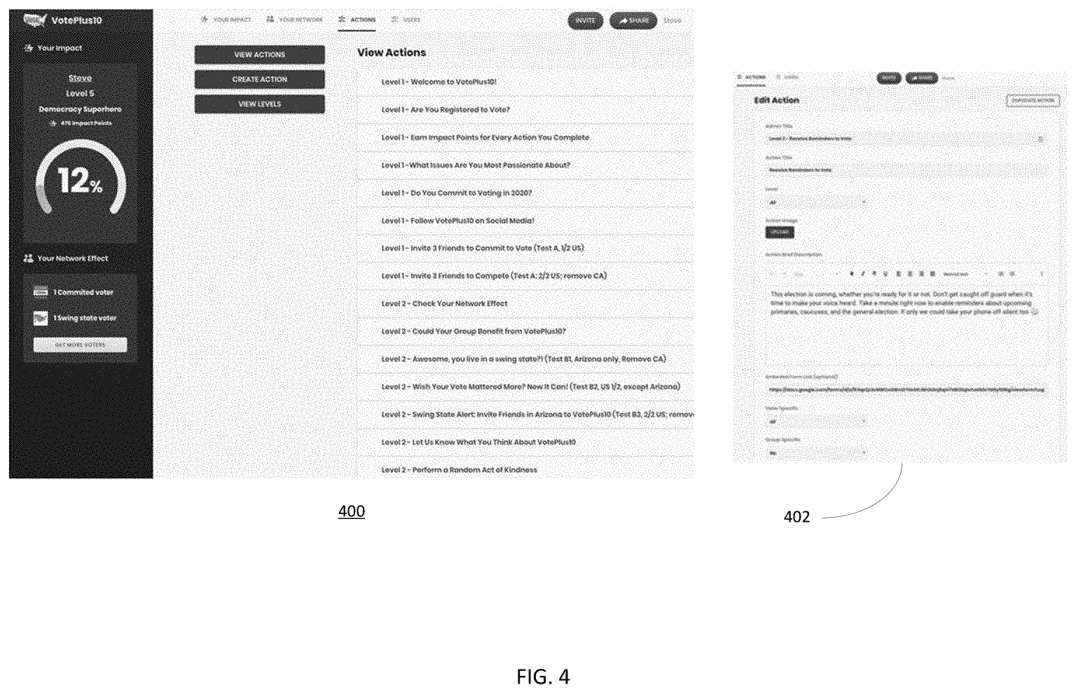

FIG. 4 illustrates a levels and tile UI 400 based on CTA creation. In some implementations, for CTA creation, an admin creates a CTA and associated attributes. They can be assigned to groups, experts, issue type, state, zip, and various other characteristics to help users associate with tile actions. A/B/Multivariate Testing is enabled (already deployed, varying tile content for select states), allowing to test and perfect content based on proven actions completed.

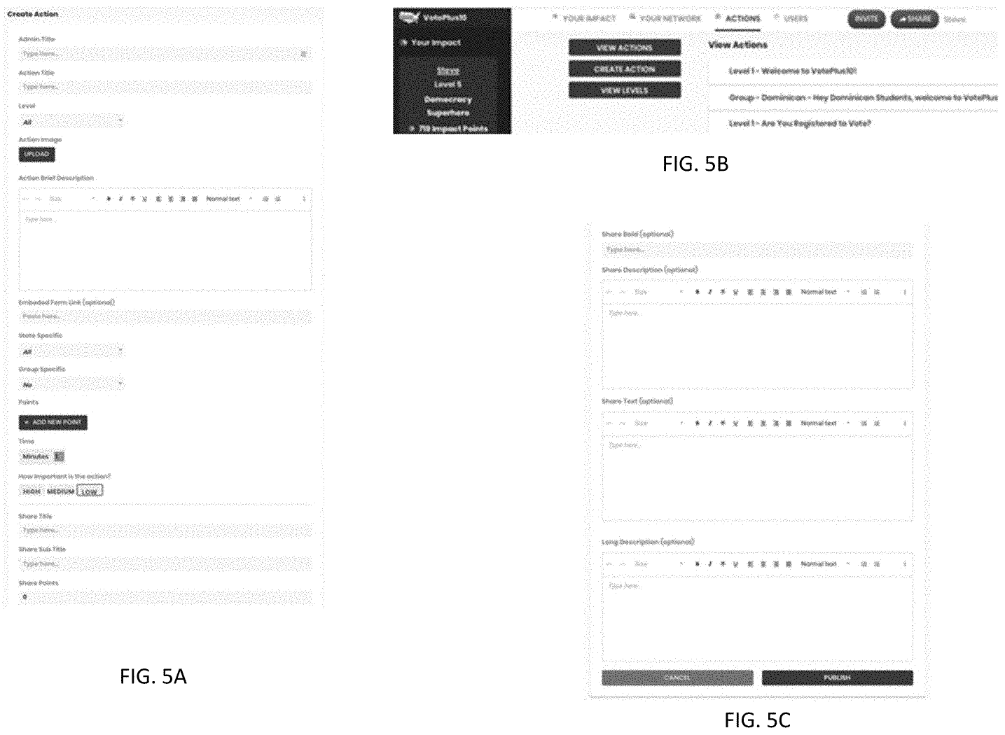

FIGS. 5A-5C illustrate CTA creation, particularly for admin/settings, etc. The creation of a CTA can include: Admin CTA Name (Admin only); CTA Title; Level; CTA Image; Brief Description; Embedded Form Link (optional); State Specific; Group Specific; Impact Points; Minutes; and How important is the action. The CTA creation can also include: Add New Point/CTA button (modal controls); and CTA button points, both of which can cause the creation of an additional admin window for modal creation and settings. The CTA screen can also include one or more functions of: Share Title; Share Sub Title; Share Points; Share Bold; Share Description; and Share Text.

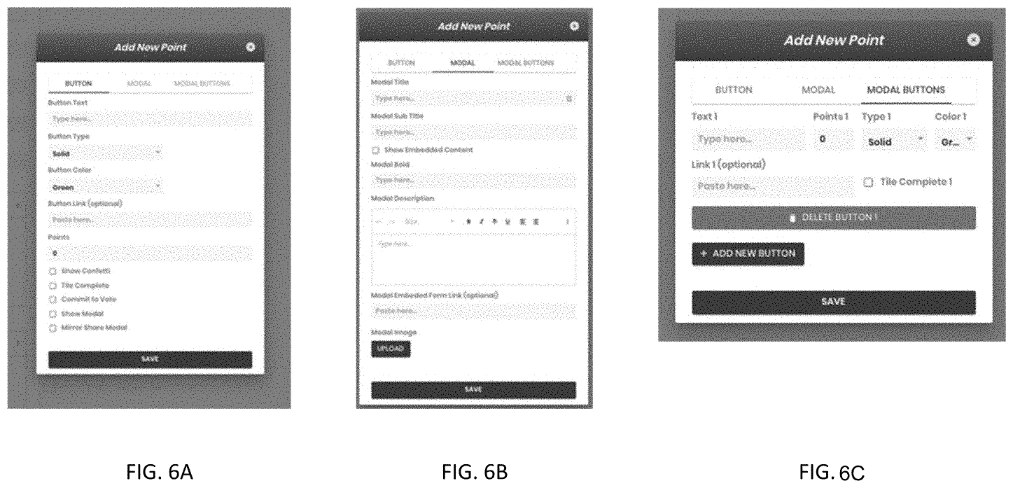

FIGS. 6A-6C illustrate button/modal creation. Buttons can include: Button Text; Button Type (solid, outline, text); Button color; Button link (optional); Button points; Check boxes; Show confetti (surprise celebration); CTA Complete (marks complete); Network points (e.g. Committed Voter); Show Modal; and Mirror Share Modal. Each modal can include: Modal title; Modal subtitle; Show Embedded Content (checkbox—which if above is checked, below options disappear and iFrame is used instead from hyperlink). A modal can further include: Modal bold; Modal description; Modal embedded form link; and Modal image (upload).

Modal buttons can include: Button 1 text; Points 1; Type 1; and Color 1. Functions can include Link1, which can be shown in a new tab or another internal modal. Another function can include: CTA/Tile Complete check box (a button that completes the associated CTA, and earns points for the user. The Add Now Point screens can further allow a user to add a new button, and save the user input for executing the functions specified by the user.

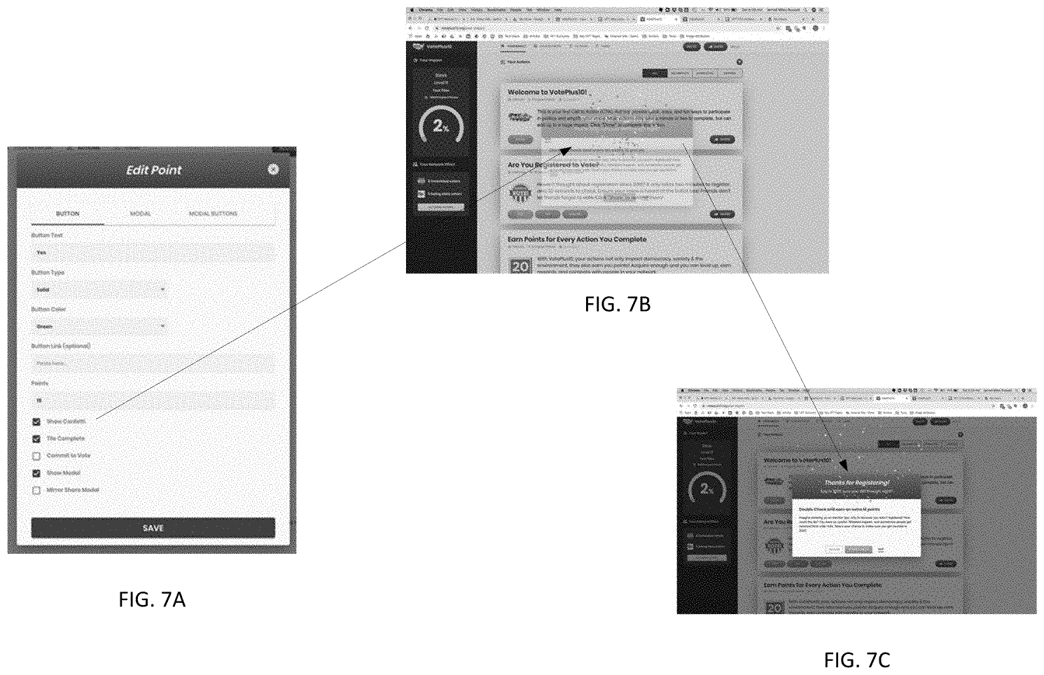

FIGS. 7A-7C illustrate a CTA completion, which can include digital “celebrations” with animations. In this example instance, the CTA completion celebration is depicted with digitally-rendered “confetti,” i.e. a digital representation of paper confetti that is showered on a display of the platform. Other celebratory designs or graphical representations of celebrations that visually rewards users for completing CTAs can be employed. The setting for such celebration graphics can be added on the backend manually for specific CTAs, or could be made into a randomized function as well.

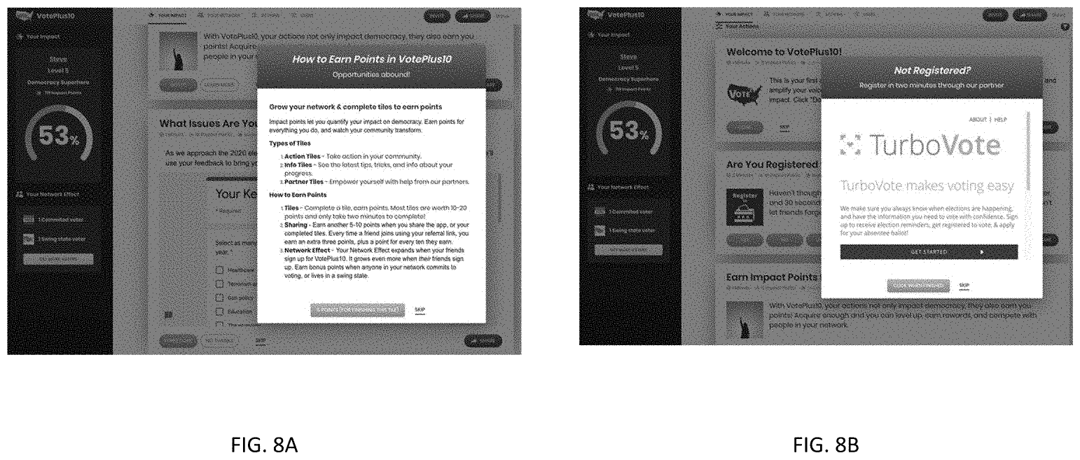

FIG. 8A depicts an exemplary modal from a user view. This is a basic modal and modal buttons without an embedded link/iFrame from an external site/integrated solution partner. FIG. 8B depicts another exemplary modal, but with an embedded link to one of one or more integrated solution providers, here shown as TurboVote™.

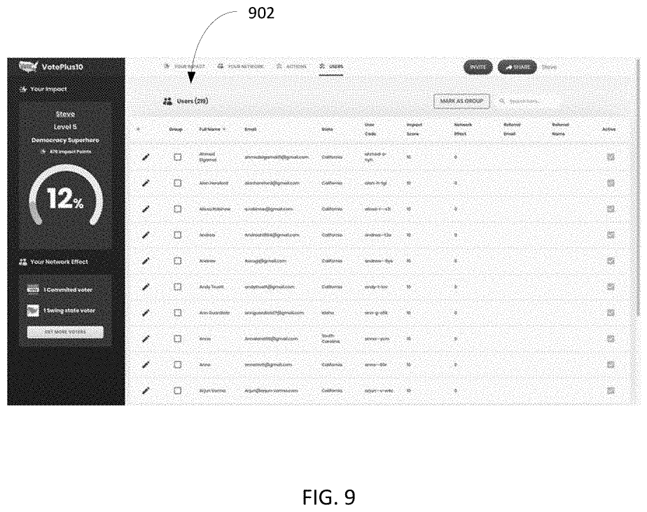

FIG. 9 shows a user table generated by the platform for users to push or send relevant, timely CTAs to other users 902 based on the groups and experts they follow, as well as user characteristics such as geography, demographics, topics of interest, etc.

CTAs make it easy to take actions and do good in the world. Points derived from user's CTAs/network provide a measurement tool as to each user's/group's progress. Centralized management of CTAs across groups protect individual user information. Thus, actions are defined in one place, and can be personalized based on user information (e.g. state, zip code, age) as well the groups, experts, and causes they follow. Points can be used to achieve new levels to allow access to new CTAs, and they also can be redeemed to earn rewards, discounts, and prizes as well as build social capital and status on leaderboards. CTAs also enable recruitment or network-building, in which unique links in the system allow users to recruit others into their network to amplify their impact and measure network results. Users can see their impact and the impact of their network in real time.

CTAs make it easy to create actions that engage stakeholders (e.g. members, volunteers, employees, etc) and do good in the world. Groups are formed and connect with users based on CTAs/causes they care about. Groups can create their own CTAs, which mix with the system's general tile composition. These CTAs can be put into an order so that all members of their group can follow the prescribed flow to complete actions and maximize impact; i.e. users can start off with simple actions and ramp up to larger, more complex actions. Each group can designate an admin with special access to create and prioritize CTAs and track related user engagement, thereby creating custom calls to action, custom branding, communications, tracking, and much more—all to maximize the impact of the network and brand. Custom CTAs can also replace verbal feedback or word-of-mouth with real actions with data and commitments. Groups can track the impact of their users, incentivize them, motivate them, etc. Integrated sharing and attribution features allow groups to grow their network and maximize impact. Partners can measure the impact their organization has across various issues based on their network's tile actions. The platform can also generate a leaderboard, by which groups can see in real time which members of their organization are most active, and which tools prove most successful at spurring your members to take action. Accordingly, with the platform described herein, groups get a straightforward tool that promotes engagement and requires no setup or training.

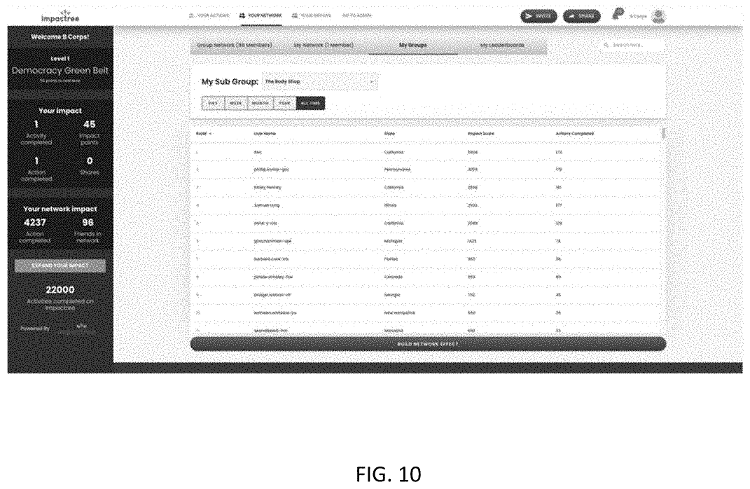

FIG. 10 shows a sub-group leaderboard. Group owners of a parent group can also produce leaderboards at the user level for each sub-group to drive competition or rewards within sub-groups and support sub-group group owners with engagement. This is very useful for segmenting engagement and impact measurement for associations, organizations with state/regional chapters, etc.

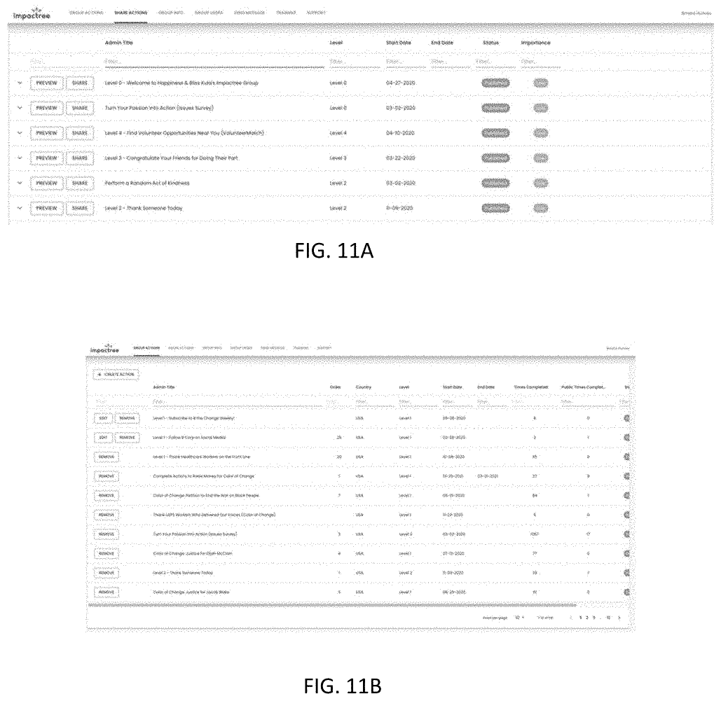

FIGS. 11A and 11B illustrate sub-group action sharing. In addition to the parent group owner being able to review and select actions for their own group based on performance at the sub-group level(s), actions from the parent group can be shared with all sub-groups, thereby allowing for customization of actions being displayed on the platform and action hubs, based on each sub-groups' needs coupled with ability of parent group to share actions with the entire ecosystem that are performing well in terms of impact/completions. Accordingly, the sub-group action sharing provides a central tool for top-down and bottom-up engagement with sub-group customization and ecosystem optimization based on engagement measurements.

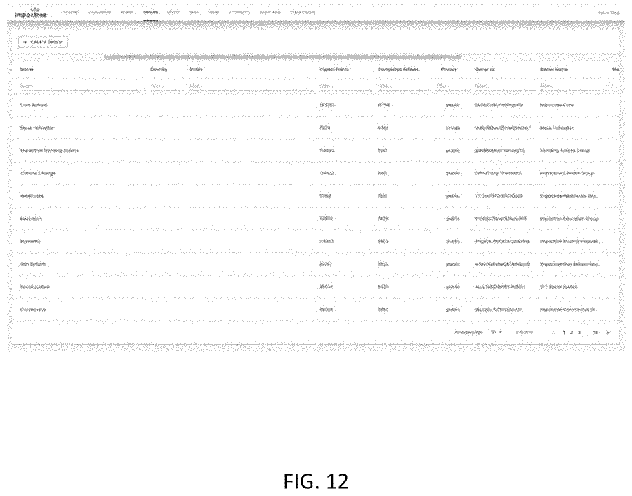

FIG. 12 illustrates a table for representing groups or group owners. The table data can include, without limitation: Name, country, states the group belongs to, and statistical attributes like Impact Points (total of all the impact points accrued by the group members), Completed Actions, Members (count of all the group members), Privacy (visible publicly or privately by invitation only), and the group owner's information—Owner Id, Owner Name. There can be a group status indication column, and one or more tags to classify the groups. These are the fields required/available to create a group with the example showing a parent-child relationship.

In some implementations, the platform can be configured to use machine-learning and other personalization algorithms to prioritize suggestions for the user by modeling their interests/preferences with inputs such as: action attributes/taxonomy, i.e. tags on actions they complete, skip, share for action type and issue area(s): forms/surveys—e.g. “Passion to Action;” groups they join on the platform; profile data (e.g. zip, state, country, level); frequency of platform use; trending actions; friends' past actions; temporal information, such as deadlines, start/end dates, etc.; interests—join groups/issue areas; accepted/completed challenges; rewards selected by redeeming points; and others.

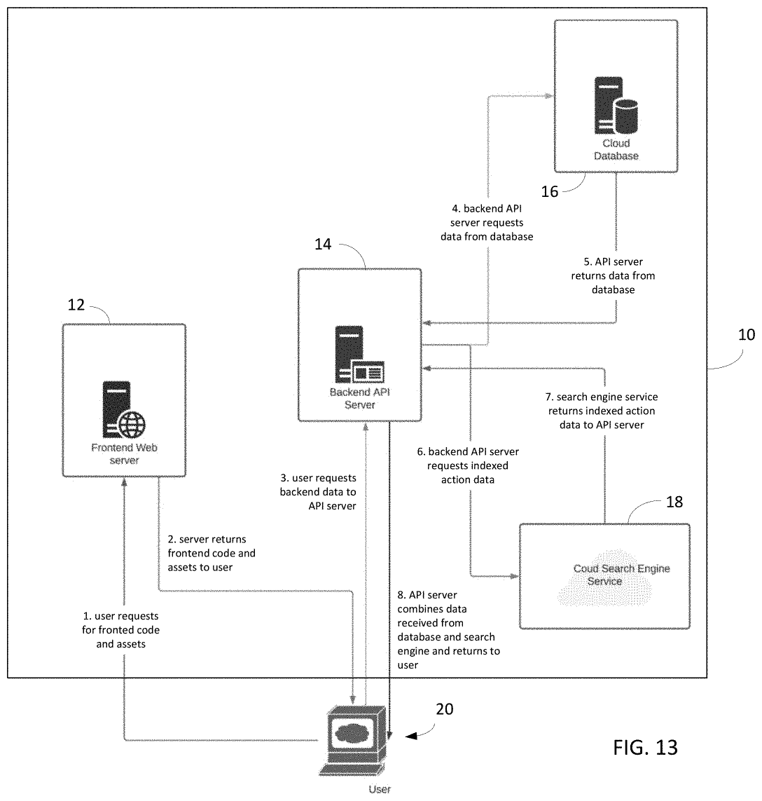

FIG. 13 illustrates a platform 10 for promoting engagement and activism in a cause, such as a political, social and/or environmental cause, where the cause is best served by actions of people, or users of the platform 10. The platform 10 is a web- or cloud-based platform 10 for communicating with one or more users via client computers 20. In preferred implementations, the platform 10 includes a frontend web server 12, a backend API server 14, a database 16 (such as a cloud storage facility or other cloud database), and a search engine service 18 that executes a search engine algorithm. The frontend web server 12 can be a single web server computer, or multiple web server computers operating in concert, each having one or more processors that can execute web server software. Likewise, the backend API server 14 can be a single API server computer or multiple API server computers. The frontend web server 12 and backend API server 14 can be hosted in a cloud computing environment.

These components of the platform 10 function as follows: at 1, a user, via a client computer 20, sends a request for frontend code and assets, namely a webpage and one or more CTAs as described herein. At 2, the server returns the fronted code and assets to the user via the client computer 20. At 3, the user, via the associated client computer 20, requests backend data from the backend API server 14. At 4, the backend API server 14 requests data from the database 16, based on the user request(s). At 5, the database 16 returns the requested data, such as a website and one or more CTAs, to the backend API server 14. At 6, the backend API server requests indexed action data (i.e. CTAs) using the cloud search engine service 18, which returns, at 7, the indexed action data to the backend API server 14. Then, at 8, the backend API server 14 combines data received from the cloud database 16 and the search engine service 18 to the client computer 20 for the user.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving, by a server computer from one or more client computers over a network, data relating to an activity to be accomplished by one or more users associated with a group, each of the one or more users further being associated with at least one of the one or more client computers, the activity;
generating, by the server computer, a call to action based on the data related to the activity, the call to action being defined as a window of a web page and having one or more user-selectable buttons related to accomplishment of the activity by a user of the one or more users;
storing, by the server computer, the call to action in a database, the storing including indexing the call to action to one or more search terms of a search request that is received by the server computer from at least one client computer via a search engine service;
accessing, by the server computer, the call to action from the database upon receipt of the search request from the at least one client computer via the search engine service, the search request including at least one of the one or more search terms indexed to the call to action in the database; and
serving, by the server computer, the call to action to the at least one client computer as the window in the web page.

2. The method in accordance with claim 1, further comprising receiving, by the server computer, data related to accomplishment of the activity by the user via the user selecting at least one of the one or more user-selectable buttons.

3. The method in accordance with claim 2, further comprising:
defining, by the server computer, one or more performance metrics associated with accomplishment of the activity by the user;
generating, by the server computer, a graphical representation of accomplishment of the activity based on the data related to accomplishment of the activity and the one or more performance metrics; and
transmitting, by the server computer, the graphical representation of accomplishment to each of the one or more client computers over the network.

4. The method in accordance with claim 3, wherein the graphical representation of accomplishment includes a graphical leaderboard that includes each of the one or more users.

5. The method in accordance with claim 1, further comprising defining, by the server computer, a point value for accomplishment of the activity.

6. A computer program product comprising a non-transitory machine-readable medium storing instructions that, when executed by at least one programmable processor of a server computer, cause the at least one programmable processor to perform operations comprising:
receiving, from one or more client computers over a network, data relating to an activity to be accomplished by one or more users associated with a group, each of the one or more users further being associated with at least one of the one or more client computers, the activity;
generating a call to action based on the data related to the activity, the call to action being defined as a window of a web page and having one or more user-selectable buttons related to accomplishment of the activity by a user of the one or more users;
storing the call to action in a database, the storing including indexing the call to action to one or more search terms of a search request that is received by the server computer from at least one client computer via a search engine service;
accessing the call to action from the database upon receipt of the search request from the at least one client computer via the search engine service, the search request including at least one of the one or more search terms indexed to the call to action in the database; and
serving the call to action to the at least one client computer as the window in the web page.

7. The computer program product in accordance with claim 6, further comprising receiving data related to accomplishment of the activity by the user via the user selecting at least one of the one or more user-selectable buttons.

8. The computer program product in accordance with claim 7, further comprising:
defining one or more performance metrics associated with accomplishment of the activity by the user;
generating a graphical representation of accomplishment of the activity based on the data related to accomplishment of the activity and the one or more performance metrics; and
transmitting the graphical representation of accomplishment to each of the one or more client computers over the network.

9. The computer program product in accordance with claim 8, wherein the graphical representation of accomplishment includes a graphical leaderboard that includes each of the one or more users.

10. The computer program product in accordance with claim 6, further comprising defining a point value for accomplishment of the activity.

11. A system for promoting engagement and activism in a cause, the system comprising:
a website that is servable to one or more client computers by a server computer, the website being configured to display one or more webpages that are generated by the server computer; and
at least one webpage associated with the website and comprising a window displaying a call to action that is based on data relating to an activity to be accomplished by one or more users of the one or more client computers, each user being associated with a group, the call to action being defined as a window of the web page and having one or more user-selectable buttons related to accomplishment of the activity by a user of the one or more users;
the call to action being accessible from the website by the one or more client computers via a search engine service that receives one or more search terms that are indexed to the call of action in a database associated with the server computer.

12. The system in accordance with claim 11, wherein each of the one or more user-selectable buttons are configured to cause transmission of data to the server computer related to accomplishment of the activity by the user.
